(19) United States
(12) Patent Application Publication
(10) Pub. No.: US 2025/0232936 A1
(43) Pub. Date: Jul. 17, 2025

(54) ELECTROMAGNETIC SYSTEM AND CONTACTOR

(71) Applicant: Chint Low Voltage Electrical Technology Co., Ltd., Songjiang District, Shanghai (CN)

(72) Inventors: Changyuan LIU, Songjiang District, Shanghai (CN); Haiyuan WANG, Songjiang District, Shanghai (CN); Jiqing HU, Songjiang District, Shanghai (CN)

(21) Appl. No.: 18/848,841

(22) PCT Filed: May 19, 2023
(86) PCT No.: PCT/CN2023/095219

§ 371 Date: Sep. 19, 2024

(30) Foreign Application Priority Data
Jun. 6, 2022 (CN) 202210630878.8

(51) Int. Cl. H01H 50/04

(52) U.S. Cl. CPC H01H 50/045

(57) ABSTRACT

Disclosed are an electromagnetic system and a contactor. The electromagnetic system includes a base and at least two electromagnetic units arranged inside the base. The base includes a wall forming an installation space for installing the electromagnetic units. Each electromagnetic unit includes a coil support used for winding a coil. A lug plate is arranged at a wire inlet end and a wire outlet end on one side, corresponding to the wall, of the coil support respectively. Each lug plate includes a connecting part. Openings are set in positions of the wall corresponding to the connecting parts of the electromagnetic units. The two electromagnetic units penetrate into the installation space from the openings through connecting wires arranged outside the wall and are connected to the connecting parts to form a connection. According to the present invention, the reliability of the product can be improved.

### TECHNICAL FIELD

The present invention relates to the field of electrical appliances, and more particularly, to an electromagnetic system and a contactor.

### BACKGROUND

A contactor is mainly one of low-voltage elements that control a motor, and mainly functions to frequently switch on, break and bear a motor circuit or a transmission and distribution power supply circuit over a long distance. The contactor generally includes a contact system, an electromagnetic system, a support/insulation system, etc., wherein the electromagnetic system includes a moving iron core, a static iron core, a coil winding, etc.

Due to a space size limitation of an electrical control cabinet, a large-scale AC contactor cannot be made large enough to increase a sufficient attraction force provided by the electromagnetic system. Therefore, as shown in FIG. 15, it is known that a contactor consists of two identical electromagnetic system components connected in series to form an electromagnetic system assembly, which provides an electromagnetic attraction force for the contactor. The electromagnetic system components are connected and integrated through serial connection of coils, that is, two coils form a system coil component by twisting and welding a wire inlet end of one coil and a wire outlet end of the other coil together through a wire. The other terminal of the two coils which is not twisted and welded serves as a wire inlet and outlet end of the system coil component. The two coils of the system coil component are arranged to respectively sleeve columns in two E-type static iron cores, and then two sets of static iron core components on which coils have been installed well are sequentially installed into the product in the same direction and fixed in a limiting manner. With this scheme, before the coils are connected and merged, it is necessary to temporarily fix enameled wire inlet and outlet ends of the coils by using an adhesive tape when the coils are wound, and incoming and outgoing enameled wires and wires are twisted and welded manually together, which is prone to the risk of sufficient soldering or wire breakage. In addition, because the electromagnetic system assembly only relies on the connection of coil wires, without the overall limiting fixation, it belongs to a soft connection. During the process of sequentially installing into the product, a connecting wire is also easily loosen or broken due to pulling, resulting in rework or quality hazards of finished products, thereby increasing the product assembly cost and reducing the stability and reliability of the product.

### SUMMARY

An object of the present invention is to overcome the defects of the prior art and provide an electromagnetic system and a contactor with high stability and reliability.

In order to achieve the above object, the present invention adopts the following technical solutions:

An electromagnetic system, comprising: a base and at least two electromagnetic units arranged inside the base, wherein the base comprises a wall forming an installation space for installing the electromagnetic units;
each electromagnetic unit comprises a coil support for winding a coil, a lug plate is respectively arranged at a wire inlet end and a wire outlet end on one side of the coil support corresponding to the wall, and the lug plate comprises a connecting part; and
an opening is set in a position of the wall corresponding to each connecting part of the electromagnetic unit, and the two electromagnetic units penetrate into the installation space via the openings through a connecting wire arranged outside the wall and form a connection with the connecting part.

Preferably, plug-in terminals that correspond to the connecting parts in shape are arranged at both ends of the connecting wire, and are directly plugged into the connecting parts to form a connection.

Preferably, the connecting wire comprises a first connecting wire; one end of the first connecting wire forms a connection with the connecting part at the wire outlet end of one electromagnetic unit; and the other end of the first connecting wire forms a connection with the connecting portion at the wire inlet end of the other electromagnetic unit.

Preferably, the connecting wire further comprises a second connecting wire and a third connecting wire; the electromagnetic system comprises a power input converter arranged at a wire outlet end of the base; one end of the second connecting wire forms a connection with the connecting part at the wire inlet end of one electromagnetic unit; the other end of the second connecting wire is connected to a first pole of the power input converter, and one end of the third connecting wire forms a connection with the connecting part at the wire outlet end of the other electromagnetic unit; and the other end of the third connecting wire is connected to a second pole of the power input converter.

Preferably, the base further comprises a wire duct formed outside the wall, and the connecting wire is arranged in the wire duct.

Preferably, the base is provided with a limiting rib for positioning the electromagnetic unit.

Preferably, the electromagnetic unit is provided with an elastic buckle, and the base is provided with a bayonet corresponding to the elastic buckle; and when the electromagnetic unit slides into the installation space inside the base and the elastic buckle reaches a position of the bayonet, the elastic buckle ejects and forms a buckle with the bayonet.

Preferably, the coil support is provided with a fixing cavity in which the lug plate is installed; the lug plate comprises a fixing part; the fixing part is plugged into the fixing cavity, and two side walls of the fixing part form an interference fit with the fixing cavity; and a barbed structure is also arranged on both sides of the fixing part.

Preferably, the lug plate comprises a wire terminal fixing part connected to a wire of the coil, and the coil support is further provided with a cover cap for at least enclosing the wire terminal fixing part of the lug plate.

Preferably, a guide groove is formed in one side of the coil support corresponding to the coil fixing part; the cover cap is provided with a guide rib corresponding to the guide groove; and the cover cap is plugged into the guide groove through the guide rib to form a connection.

Preferably, a plugging direction of the cover cap, the coil support is further provided with a limiting bract, and a limiting buckle is arranged at a plugging end of the cover cap, corresponding to the limiting bract; and after the cover cap is plugged, the limiting bract forms clamping with the limiting buckle.

Preferably, a first limiting rib is further arranged at the plugging end of the cover cap; the coil support is provided with a second limiting rib; and after the cover cap is plugged, the first limiting rib and the second limiting rib form mutual limiting in a direction perpendicular to the plugging direction.

Preferably, a protective partition plate is further arranged at the bottom of the base.

The present invention also provides a contactor, comprising an electromagnetic system, a contact system and an arc extinguishing system, the electromagnetic system is the electromagnetic system as above-mentioned.

The present invention provides the structures of the contactor and the electromagnetic system. The electromagnetic units are installed inside the base. The electromagnetic units form a coil assembly through connecting wires set outside the base, which solves the problems of inconvenience in assembly and movement, and the potential uses of broken wires and insufficient soldering that may occur during the process of connecting the electromagnetic units externally and then installing them inside the product. It achieves the effect of allowing the static iron core assembly to be installed from both sides of the product base, with external coil connections, ensuring stability and reliability. In addition, the enameled wire of the coil may be automatically wound to the wire terminal fixing part of the lug plate assembled and fixed in advance. The enameled wire inlet and outlet ends are fixed by welding, which eliminates the need for manual temporary use of adhesive tape to fix the inlets and outlets ends of the enameled wire, thereby increasing the connection reliability and stability of the coil components and reducing the manufacturing cost of the coil components.

In addition, a lug plate is included. The lug plate includes a fixing part, a welding part and a plug-and-unplug connecting part structure, wherein the fixing part has a barbed structure which is in interference fit with a cavity adapted with the coil, thereby achieving the fixing stability of the lug plate. The welding part may provide an incoming and outgoing wire fixing space for the enameled wire of the coil, and the enameled wire is fixed through the welding process. The plug-and-unplug connecting part provides a structure that is matched with a quick-plug terminal, thereby achieving the functions that the coils can be installed from both sides of the base of the contactor and connected externally by the quick-plug terminal. The lug plate only needs to be reversed into a coil skeleton fixing cavity when applied, and there is no need to add another lug plate part, thereby reducing the expenditure on mold production.

In addition, after the coil structure is adopted, two cover caps are included. The two cover caps are respectively arranged at the two lug plates of the coil support, and each cover cap has an accommodating cavity, two buckles, and a guided limiting structure. The accommodating cavity is used to accommodate the wire terminal fixing part of the lug plates, reducing the process of bending the lug plates after welding, which in turn reduces the complexity of applying coil welding terminal, lowers the assembly cost, and enhances the dielectric performance of the coil welding terminal to prevent arcing at the tips of the lug plates. The buckle structure is adapted to the convex bract structure at the corresponding position of the coil skeleton, so that the cover cap cannot detach from the coil skeleton. The guided limiting structure facilitates the positioning and assembly of the cover cap.

Furthermore, a limiting rib surface structure may be added to the cover cap and is adapted to a coil firmware response groove, thereby achieving the effect of preventing the product from detaching due to vibration during the on-off movement.

Finally, in this embodiment, at least one protective cover is added to the bottom to avoid the exposure of internal parts of the product, isolate the risk of external foreign object intrusion, and improve the protective capacity and the reliability of the product.

### BRIEF DESCRIPTION OF THE DRAWINGS

FIG. 1 is a schematic structural diagram of a contactor in the present invention;

FIG. 2 is a schematic diagram of an assembly process of an electromagnetic unit and a base in the present invention;

FIG. 3 is a schematic diagram of an assembly process of the electromagnetic unit, a connecting wire and an end cover in the present invention;

FIG. 4 is a schematic structural diagram of the electromagnetic unit in the present invention;

FIG. 5 is a schematic diagram of an assembly process of the electromagnetic unit in the present invention;

FIG. 6 is a schematic diagram of an assembly process of a lug plate, a cover cap and a coil support in the present invention;

FIG. 7 is a schematic structural diagram of the coil support in the present invention;

FIG. 8 is a schematic structural diagram of the lug plate in the present invention;

FIG. 9 is a schematic structural diagram of the cover cap in the present invention;

FIG. 10 is a schematic structural diagram of a wall of the base in the present invention;

FIG. 11 is a schematic structural diagram of a bottom of the contactor in the present invention;

FIG. 12 is a schematic structural diagram of a protective cover in the present invention;

FIG. 13 is a schematic structural diagram of a side surface of the contactor in the present invention;

FIG. 14 is an enlarged view at E in FIG. 13; and

FIG. 15 is a schematic diagram of an assembly process of an existing contactor.

### DETAILED DESCRIPTION OF THE INVENTION

The specific implementations of an electromagnetic system and a contactor of the present invention will be further described below with reference to the embodiments given in the accompanying diagrams. The electromagnetic system and the contactor of the present invention are not limited to the description of the following embodiments.

As shown in FIGS. 1-3, this embodiment provides a contactor 10. The contactor 10 includes an electromagnetic system 101, a contact system (not shown), and an arc extinguishing system 103.

The electromagnetic system includes a base 9 and at least two electromagnetic units 7 arranged inside the base 9, wherein the base 9 includes a wall 90 forming an installation space 90a for installing the electromagnetic units 7. In some embodiments, more than two electromagnetic units 7 are arranged according to the requirements for the attraction force.

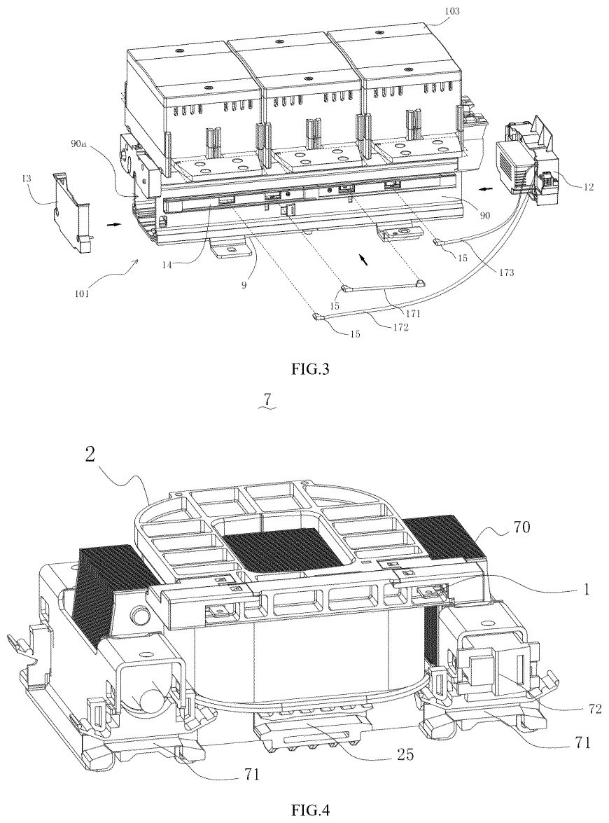

As shown in FIGS. 3-9, each electromagnetic unit 7 includes a coil 26, a coil support 20 for winding the coil 26, and a magnetic yoke assembly 70. A lug plate 1 is respectively arranged at a wire inlet end and a wire outlet end on one side of the coil support 20 corresponding to the wall 90 of the base 9. The lug plate 1 includes a wire terminal fixing part 12a and a connecting part 13a. The wire terminal fixing part 12a is connected to a wire of the coil 26. The wire terminal fixing part 12a on one side of the wire inlet end is used for fixing a wire at the wire inlet end. The wire terminal fixing part 12a at the wire outlet end is used for fixing a wire at the wire outlet end. The connecting part 13a is used for serial connection or parallel connection between an external connecting wire 17 and the other electromagnetic unit 7.

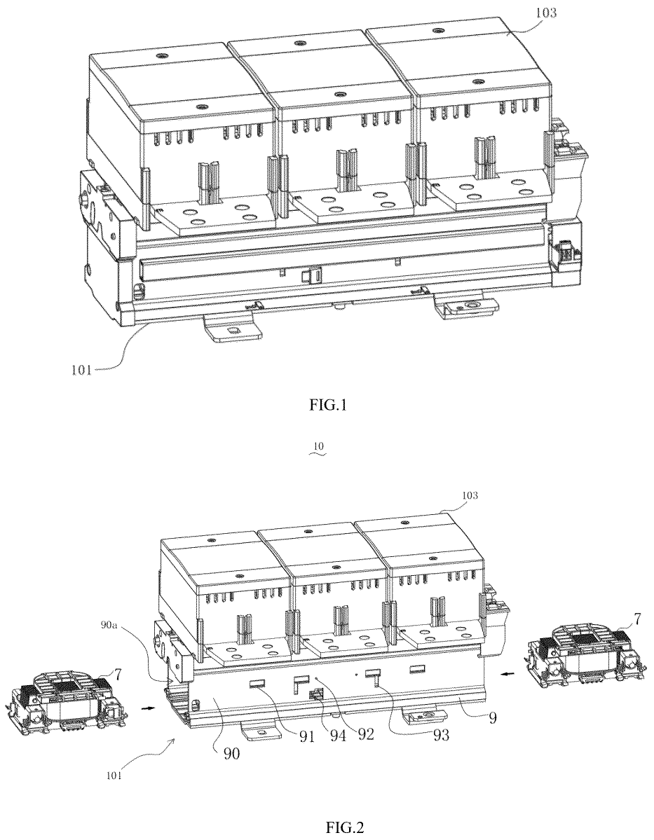

Continued to FIGS. 2-3, the base 9 has two sides and a bottom wall. In this embodiment, an opening 91 is set in a position of the wall 90 on one side corresponding to the connecting part 13a of each electromagnetic unit 7, and the two electromagnetic units 7 penetrate into the installation space 90a via the openings 91 through the connecting wire 17 arranged outside the wall 90 and are connected in series or parallel with the connecting part 13a.

In some embodiments, in the case of more than two electromagnetic units 7, the number of the openings 91 corresponding to the wall 90 is increased accordingly.

In some embodiments, the lug plates 1 at the wire inlet end and the wire outlet end may also correspond to different walls of the base 9, and the openings 91 at this moment may be set in the walls on two opposite sides respectively.

In some embodiments, the lug plates 1 at the wire inlet end and the wire outlet end may also correspond to the bottom wall of the base 9, and the openings 91 at this moment may be formed in the bottom wall.

As shown in FIGS. 2-3, the two electromagnetic units 7 in this embodiment may be connected through the connecting wire 17 to increase an attraction force of the electromagnetic system 101 to the contact system. Specifically, the two electromagnetic units 7 may form a serial or parallel connection form through the connecting wire 17, the two electromagnetic units 7 are installed in the installation space 90a, and the connecting wire 17 is located outside the installation space 90a.

In this embodiment, plug-in terminals 15 that correspond to the connecting parts 13a in shape are arranged at both ends of the connecting wire 17, and are directly plugged into the connecting parts 13a to form a connection. A rapid connection is achieved by the plug-in terminals 15.

As a specific implementation, as shown in FIG. 2, the two electromagnetic units 7 are connected in series. Specifically, the connecting wire 17 includes a first connecting wire 171; one end of the first connecting wire 171 forms a connection with the connecting part 13a at the wire outlet end of one electromagnetic unit 7; and the other end of the first connecting wire 171 forms a connection with the connecting part 13a at the wire inlet end of the other electromagnetic unit 7.

Further, the connecting wire 17 further includes a second connecting wire 172 and a third connecting wire 173. The electromagnetic system includes a power input converter 12 arranged at a wire outlet end of the base 9. One end of the second connecting wire 172 forms a connection with the connecting part 13a at the wire inlet end of one electromagnetic unit 7, and the other end of the second connecting wire 172 is connected to a first pole of the power input converter 12. One end of the third connecting wire 173 forms a connection with the connecting part 13a at the wire outlet end of the other electromagnetic unit 7, and the other end of the third connecting wire 173 is connected to a second pole of the power input converter 12.

Based on the above first connecting wire 171, second connecting wire 172, third connecting wire 173 and power input converter 12, the two electromagnetic units 7 form a serial connection structure.

As another specific implementation, a parallel connection structure of the two electromagnetic units 7 can be realized by different connecting modes of connecting wires.

In this embodiment, the two electromagnetic units 7 are arranged on the same side of the lug plate. Therefore, a wire duct 14 may also be formed outside the base 9. The wire duct 14 is arranged outside the wall 90 through a screw hole 92. The connecting wire 17 is arranged in the wire duct 14. Therefore, the connecting wire may be attached to the surface of the wall 90 without being messy, which keeps the wall surface of the base 9 tidy, helps protect the connection reliability of the connecting wire 17 at the same time, and is not easy to be scratched and come out.

Of course, in the case that the lug plates 1 are arranged on different sides, different wall surfaces may also be separately provided with the wire ducts to realize the storage of the connecting wire 17.

Continuing with reference to FIGS. 2-4 and 10, in this embodiment, the electromagnetic unit 7 is installed by sliding from both sides of the base 9 into the internal installation space 90a of the base 9. A sliding chute 71 is provided on both sides at the bottom of the magnetic yoke assembly 70, and a slide rail 95 is arranged inside the base 9. The sliding process is realized through the interaction of the sliding chute 71 and the slide rail 95. In order to align the connecting part 13a of the lug plate 1 with the opening 91, a limiting rib 93 for positioning the electromagnetic unit 7 is arranged inside the base 9. When the electromagnetic unit 7 is slid into the installation space 90a from both ends of the base 9 and butted against the limiting rib 93, the connecting part 13a of the lug plate 1 is precisely aligned with the opening 91, so that the plug-in terminal 15 of the external connecting wire 17 may be plugged from the opening 91.

After the electromagnetic units 7 are installed well, the end cover 13 and the power input converter 12 may be respectively installed into both ends of the base 9, and then the assembly process of the closed base 9 is realized.

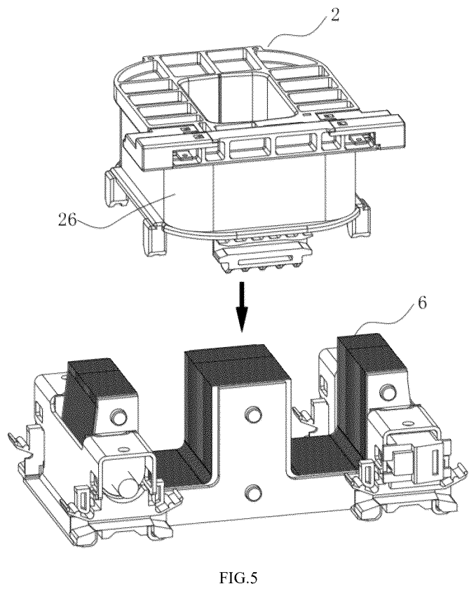

Continuing with reference to FIG. 2 and FIG. 4, in this embodiment, the electromagnetic unit 7 is also provided with an elastic buckle 72, and the base 9 is provided with a bayonet 94 corresponding to the elastic buckle 72. When the electromagnetic unit 7 is slid into the installation space 90a inside the base 9 and the elastic buckle 72 reaches the position of the bayonet 94, the elastic buckle 72 ejects and forms a buckle with the bayonet 94. This mechanism prevents the electromagnetic unit 7 from slipping after it is properly positioned inside the base 9, which could cause misalignment of the lug plate 1. Additionally, it avoids the impact on connection reliability that might be caused by the stress on the plug-in terminals 15 due to vibrations and misalignment during use.

Continuing with reference to FIGS. 7-8, the coil support 20 is provided with a fixing cavity 23 in which the lug plate 1 is installed; the lug plate 1 includes a fixing part 11; the fixing part 11 is plugged into the fixing cavity 23, and two side walls of the fixing part 11 form an interference fit with the fixing cavity 23; and a barbed structure is also arranged on both sides of the fixing part 11. This ensures that the lug plate 1 is securely fixed and will not become disengaged or fail when reasonable external force is applied to assemble or disassemble the terminal 15. Specifically, in the embodiment as shown in FIG. 8, the lug plate 1 includes the connecting part 13a, a wire terminal fixing part 12a connected to the wire of the coil 26, and a fixing part 11 connected to the coil support 20, wherein the lug plate 1 is integrally formed, the connecting part 13a and the fixing part 11 form an I-shaped sheet structure, and the wire terminal fixing part 12a is arranged by protruding and extending from a side edge of the I-shaped sheet structure.

A notch 26 is formed on one side of the fixing cavity 23, and the wire terminal fixing part 12a extends out of the notch 26. When the coil 26 is wound with the wire, the wire (taking an enameled wire as an example) inlet and outlet ends may be temporarily fixed by winding the wire on the wire terminal fixing part 12a of the lug plate 1 for several turns. Then, incoming and outgoing enameled wires are welded onto the wire terminal fixing part 12A through a welding process, such that the enameled wire is reliably fixed. The winding process meets the needs for automated production, reducing the production costs and improving the stability of the coil quality.

The fixing cavity 23 has a size greater than that of the connecting part 13a, and a slot for accommodating the plug-in terminal 15 is formed between the fixing cavity 23 and the connecting part 13a.

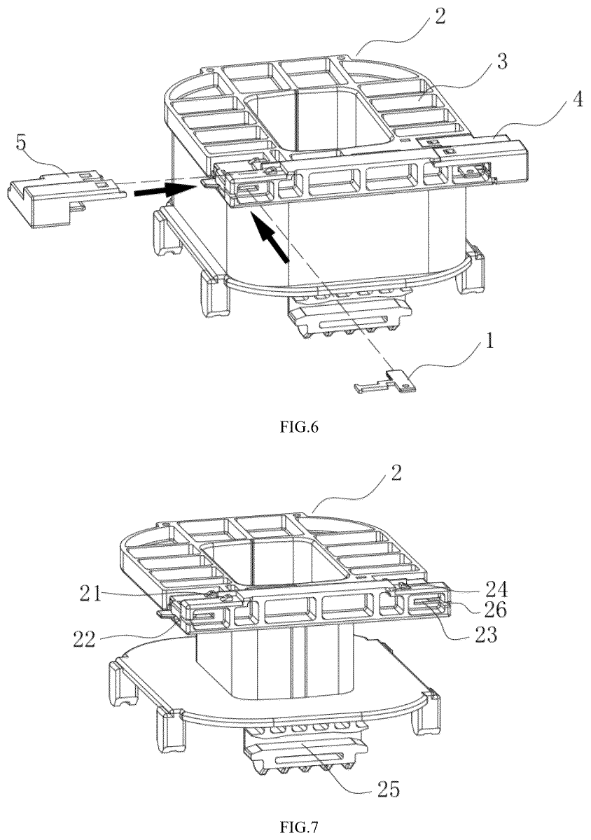

As a further improvement in this embodiment, as shown in FIG. 6, the coil support 20 is further provided with a cover cap 5 for at least enclosing the wire terminal fixing part 12a of the lug plate 1. Specifically, the cover cap 5 is provided with an accommodating cavity 52 which may enclose the lug plate 1 on the coil support 20. With the provision of cover cap 5, the wire terminal fixing part 12a of the lug plate 1 does not need to be bent, and the cover cap 5 may directly enclose the lug plate 1, thereby avoiding point discharge, enhancing dielectric performance, and improving safety.

Further, as shown in FIG. 6 and FIG. 7, a guide groove 22 is set on one side of the coil support 20 corresponding to the coil fixing part 12; the cover cap 5 is provided with a guide rib 51 corresponding to the guide groove 22; and the cover cap 5 is plugged into the guide groove 22 through the guide rib 51 to form a connection.

Further, as shown in FIG. 7 and FIG. 9, in a plugging direction of the cover cap 5, the coil support 20 is further provided with a limiting bract 21, and a limiting buckle 54 is arranged at a plugging end of the cover cap 5 corresponding to the limiting bract 21; and after the cover cap 5 is plugged, the limiting bract 21 forms clamping with the limiting buckle 54. In this way, the cover cap 5 can be prevented from loosening and sliding out.

Further, in order to prevent upper and lower vibrations of the product from having an impact on the cover cap 5 when the product is working, a first limiting rib 53 is also arranged at the plugging end of the cover cap 5. The coil support 20 is provided with a second limiting rib 24. After the cover cap 5 is plugged, the first limiting rib 53 and the second limiting rib 24 form mutual limiting in a direction perpendicular to the plugging direction. It is further ensured that the cover cap 5 does not vibrate vertically due to the vibration when the product is working, preventing the cover cap 5 from failing to buckle and slide.

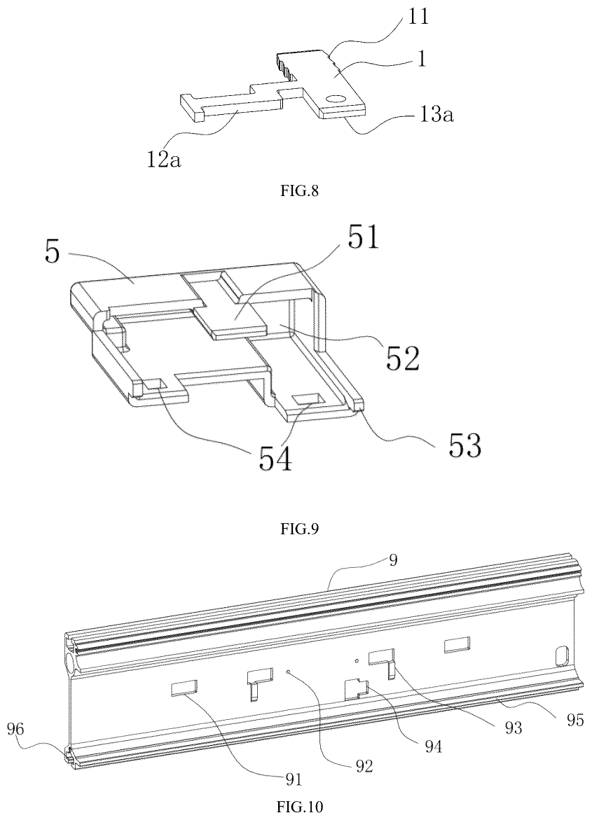

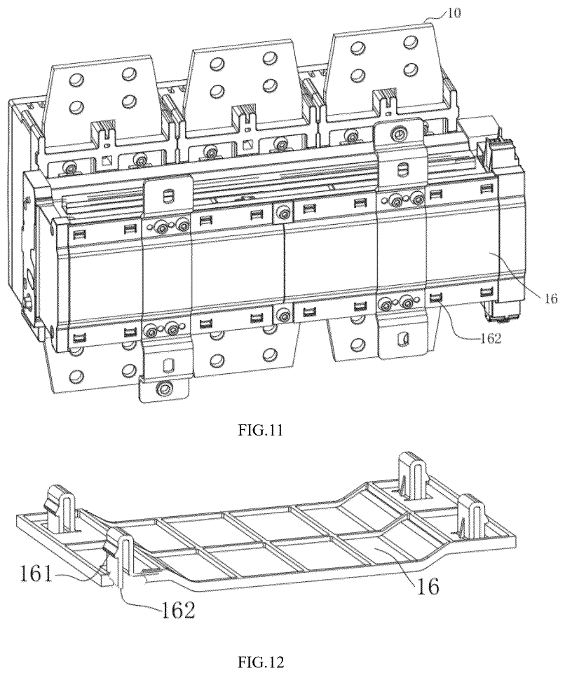

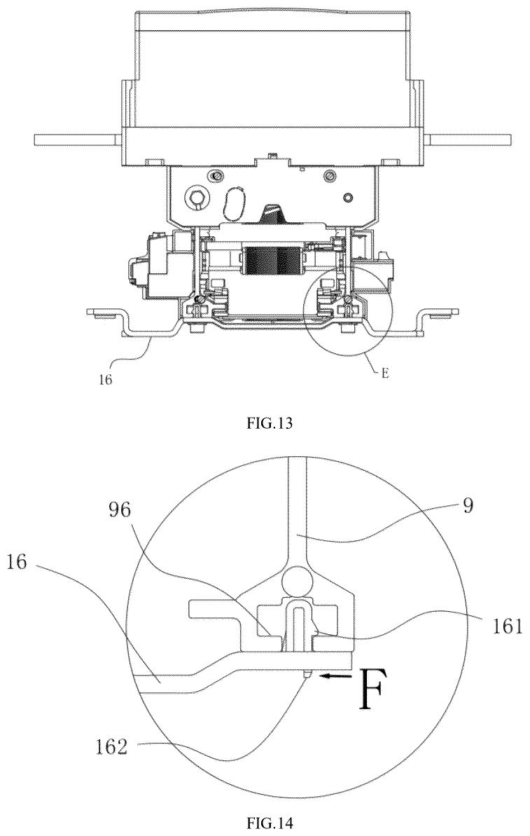

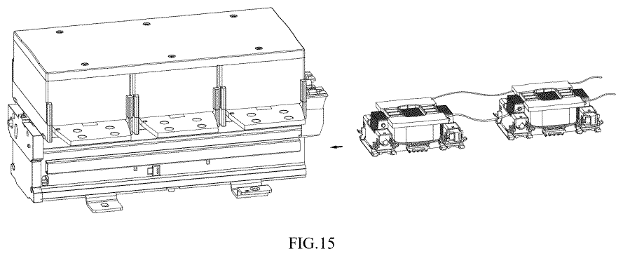

Continuing with reference to FIGS. 10-14, a protective partition plate 16 is also arranged at the bottom of the base 9 and used for increasing the protective capacity of the product. Specifically, at least one protective partition plate 16 is additionally arranged at the bottom of the contactor 10 product, and the buckle 161 in at least one place on the protective partition plate 16 is clamped in a clamping slot 96 adapted to the base 9, so that the protective partition plate 16 is clamped and fixed. The buckle 161 adopts a design of a suspended structure at one end, which not only increases the elasticity of the buckle 161, but also is conducive to the mold opening production. Meanwhile, this suspended end has a surface higher than the protective partition plate 16, and a buckle rib surface 162 that is elevated can be pressed with bare hands, such that the buckle rib surface 162 can be deformed, and the buckle 161 is separated from the clamping slot 96 of the base 9, which is conductive to the disassembly of the protective partition plate.

The structures of the contactor and the electromagnetic system provided in this embodiment are described above. Based on this embodiment, the electromagnetic units are installed inside the base. The electromagnetic units form a coil assembly through connecting wires set outside the base, which solves the problems of inconvenience in assembly and movement, and the potential uses of broken wires and insufficient soldering that may occur during the process of connecting the electromagnetic units externally and then installing them inside the product. It achieves the effect of allowing the static iron core assembly to be installed from both sides of the product base, with external coil connections, ensuring stability and reliability.

In addition, the enameled wire of the coil may be automatically wound to the wire terminal fixing part of the lug plate assembled and fixed in advance. The enameled wire inlet and outlet ends are fixed by welding, which eliminates the need for manual temporary use of adhesive tape to fix the inlets and outlets ends of the enameled wire, thereby increasing the connection reliability and stability of the coil components and reducing the manufacturing cost of the coil components. In addition, a lug plate is included. The lug plate includes a fixing part, a welding part and a plug-and-unplug connecting part structure, wherein the fixing part has a barbed structure which is in interference fit with a cavity adapted with the coil, thereby achieving the fixing stability of the lug plate. The welding part may provide an incoming and outgoing wire fixing space for the enameled wire of the coil, and the enameled wire is fixed through the welding process. The plug-and-unplug connecting part provides a structure that is matched with a quick-plug terminal, thereby achieving the functions that the coils can be installed from both sides of the base of the contactor and connected externally by the quick-plug terminal. The lug plate only needs to be reversed into a coil skeleton fixing cavity when applied, and there is no need to add another lug plate part, thereby reducing the expenditure on mold production.

In addition, after the coil structure is adopted, two cover caps are included. The two cover caps are respectively arranged at the two lug plates of the coil support, and each cover cap has an accommodating cavity, two buckles, and a guided limiting structure. The accommodating cavity is used to accommodate the wire terminal fixing part of the lug plates, reducing the process of bending the lug plates after welding, which in turn reduces the complexity of applying coil welding terminal, lowers the assembly cost, and enhances the dielectric performance of the coil welding terminal to prevent arcing at the tips of the lug plates. The buckle structure is adapted to the convex bract structure at the corresponding position of the coil skeleton, so that the cover cap cannot detach from the coil skeleton. The guided limiting structure facilitates the positioning and assembly of the cover cap.

Furthermore, a limiting rib surface structure may be added to the cover cap and is adapted to a coil firmware response groove, thereby achieving the effect of preventing the product from detaching due to vibration during the on-off movement.

Finally, in this embodiment, at least one protective cover is added to the bottom to avoid the bareness of internal parts of the product, isolate the risk of external foreign object intrusion, and improve the protective capacity and the reliability of the product.

It should be explained that, in the description of the present invention, the terms such as “up”, “down”, “left”, “right”, “inner” and “outer” indicating the directional or positional relations on the basis of the directional or positional relations shown in the drawings are only used for conveniently describing the present invention and simplifying the description, not indicate or imply that the referred devices or elements must have a specific orientation and be configured and operated in a specific direction; therefore, they cannot be construed as a limitation on the present invention.

We have made further detailed description of the present invention mentioned above in combination with specific preferred embodiments, but it is not deemed that the specific embodiments of the present invention is only limited to these descriptions. A person skilled in the art can also, without departing from the concept of the present invention, make several simple deductions or substitutions, which all be deemed to fall within the protection scope of the present invention.

1. An electromagnetic system, comprising: a base and at least two electromagnetic units arranged inside the base, wherein the base-comprises a wall forming an installation space for installing the electromagnetic units;
each electromagnetic unit comprises a coil support for winding a coil, a lug plate is respectively arranged at a wire inlet end and a wire outlet end on one side of the coil support corresponding to the wall, and the lug plate comprises a connecting part; and
an opening is set in a position of the wall corresponding to each connecting part of the electromagnetic unit and the two electromagnetic units penetrate into the installation space via the openings through a connecting wire arranged outside the wall and form a connection with the connecting part.

2. The electromagnetic system according to claim 1, wherein plug-in terminals that correspond to the connecting parts in shape are arranged at both ends of the connecting wire, and are directly plugged into the connecting parts to form a connection.

3. The electromagnetic system according to claim 1, wherein the connecting wire comprises a first connecting wire; one end of the first connecting wire forms a connection with the connecting part at the wire outlet end of one electromagnetic unit; and the other end of the first connecting wire forms a connection with the connecting portion at the wire inlet end of the other electromagnetic unit.

4. The electromagnetic system according to claim 2, wherein the connecting wire further comprises a second connecting wire and a third connecting wire; the electromagnetic system comprises a power input converter arranged at a wire outlet end of the base; one end of the second connecting wire forms a connection with the connecting part at the wire inlet end of one electromagnetic unit; the other end of the second connecting wire is connected to a first pole of the power input converter, and one end of the third connecting wire forms a connection with the connecting part at the wire outlet end of the other electromagnetic unit; and the other end of the third connecting wire is connected to a second pole of the power input converter.

5. The electromagnetic system according to claim 1, wherein the base further comprises a wire duct formed outside the wall, and the connecting wire is arranged in the wire duct.

6. The electromagnetic system according to claim 1, wherein the base is provided with a limiting rib for positioning the electromagnetic unit.

7. The electromagnetic system according to claim 1, wherein the electromagnetic unit is provided with an elastic buckle, and the base is provided with a bayonet corresponding to the elastic buckle; and when the electromagnetic unit slides into the installation space inside the base and the elastic buckle reaches a position of the bayonet, the elastic buckle ejects and forms a buckle with the bayonet.

8. The electromagnetic system according to claim 1, wherein the coil support is provided with a fixing cavity in which the lug plate is installed; the lug plate comprises a fixing part; the fixing part is plugged into the fixing cavity, and two side walls of the fixing part form an interference fit with the fixing cavity; and a barbed structure is also arranged on both sides of the fixing part.

9. The electromagnetic system according to claim 1, wherein the lug plate comprises a wire terminal fixing part connected to a wire of the coil, and the coil support is further provided with a cover cap for at least enclosing the wire terminal fixing part of the lug plate.

10. The electromagnetic system according to claim 9, wherein a guide groove is formed in one side of the coil support corresponding to the coil fixing part; the cover cap is provided with a guide rib corresponding to the guide groove; and the cover cap is plugged into the guide groove through the guide rib to form a connection.

11. The electromagnetic system according to claim 10, wherein in a plugging direction of the cover cap, the coil support is further provided with a limiting bract, and a limiting buckle is arranged at a plugging end of the cover cap corresponding to the limiting bract; and after the cover cap is plugged, the limiting bract forms clamping with the limiting buckle.

12. The electromagnetic system according to claim 11, wherein a first limiting rib is also arranged at the plugging end of the cover cap; the coil support is provided with a second limiting rib; and after the cover cap is plugged, the first limiting rib and the second limiting rib form mutual limiting in a direction perpendicular to the plugging direction.

13. The electromagnetic system according to claim 1, wherein a protective partition plate is also arranged at the bottom of the base.

14. A contactor, comprising an electromagnetic system, a contact system and an arc extinguishing system, wherein the electromagnetic system is the electromagnetic system according to claim 1.
